(19) United States
(12) Patent Application Publication
(10) Pub. No.: US 2005/0031940 A1
(43) Pub. Date: Feb. 10, 2005

(54) Battery storage apparatus

(76) Inventor: Ernest R. Chacon, Philo, CA (US)

Correspondence Address: ORRICK, HERRINGTON & SUTCLIFFE, LLP, 4 PARK PLAZA, SUITE 1600, IRVINE, CA, 92614-2558, US

(21) Appl. No.: 10/638,159

(22) Filed: Aug. 7, 2003

(51) Int. Cl. H01M 2/10

(52) U.S. Cl. 429/100; 429/48; 429/99

(57) ABSTRACT

A novel housing apparatus that identifies, stores, protects, categorizes, separates, and organizes batteries. The housing apparatus comprises a non-conductive sleeve with an open end and a closed end, said sleeve being dimensioned to conform closely to and receive a battery. Upon insertion of the battery in the open end of one sleeve, the Positive terminal and/or the Negative terminal is protected from accidental discharge. The housing apparatus comprises a plurality of colors for enabling color coordination with existing batteries and/or service life.

### BACKGROUND

1. Field of the Invention

The present invention relates to storage devices, and more particularly battery storage devices that may serve to identify, store, protect, categorize, separate, and organize batteries, in addition to preventing accidental battery discharge.

2. Background

Batteries are used in numerous personal and commercial devices. Many of these devices will only operate with a battery as opposed to an electrical outlet. An example is the television remote control device. Batteries are therefore a necessary element of the operability of such devices. Even if the device is capable of operating by an outlet, often times the user does not have an electrical outlet in a convenient location and must depend on a battery to operate the device.

Many households and businesses have batteries at hand that are not currently being used in a device. There are a variety of methods for storing and identifying such batteries. For instance, some batteries are left unopened in their original commercial packaging, indicating to the user that the batteries have not been used and are presumably fully charged. However, the user may take some but not all of the batteries out of the original commercial packaging, insert into a device, and leave the remainder unused. Because the original commercial packaging is usually similarly shaped like the battery itself, it can provide a place holder for the remaining batteries. In addition, some users, after they have used the battery for only a short while or before the battery has died, put the battery back into the original commercial packaging to signify that the battery is not dead. Regardless of the reason for using the original commercial packaging, the batteries are not completely secure in this holding place and can easily fall out. Moreover, such practices can lead to confusion about which batteries are fresh and which are dead.

Another common practice is to store left-over or unused batteries into the ubiquitous kitchen junk-drawer or other disorganized storage place, such as a camera bag. As a result, it becomes difficult for the user to determine which batteries are fully powered and which are not. Sometimes these loose batteries may be discarded prematurely because their condition cannot be accurately determined.

Further, loose or exposed batteries can come into contact with conductive items, which can cause rapid discharge of the battery. Thus, a user may believe such batteries to be new, and in fact the batteries might be new, but which in reality have a compromised service life. In addition, poor battery life can result by intermixing different brands or by use of same-brand batteries that have not all been placed in service in the same condition at the same time. One discharged battery will tend to prematurely drag down the usable voltage of the other batteries in use. Storing batteries in sets helps to improve battery service life, and at the end of service batteries should be disposed of in sets.

In view of the above, there is a long felt need for a storage apparatus that securely organizes batteries based on service life, and prevents premature discharge.

### SUMMARY

Therefore, aspects of the various embodiments disclosed herein provide a storage container or housing apparatus for batteries that identifies, protects, categorizes, separates, organizes, and/or preserves the service life of batteries. It is to be understood the various embodiments disclosed herein may serve other functions in addition to or separate from those identified.

It is another aspect of the various embodiments disclosed herein to provide a battery housing apparatus for a single battery, or multiple batteries.

It is another aspect of the various embodiments disclosed herein to provide a battery housing apparatus having a wide variety of sizes to accommodate a range of battery needs.

It is another aspect of the various embodiments disclosed herein to provide a battery housing apparatus for Alkaline, NiCad, Lithium Ion, or Nickel-Metal Hydride batteries, as well as for other developing battery chemistries, regardless of their shape or size.

It is another aspect of the various embodiments disclosed herein to provide a battery housing apparatus that protects either the Positive terminal, the Negative terminal, or both, in order to prevent accidental battery discharge.

It is another aspect of the various embodiments disclosed herein to provide a battery housing apparatus in an assortment of colors for enabling color coordination with existing batteries and/or service life.

It is another aspect of the various embodiments disclosed herein to provide a battery housing apparatus for manufacturers who ship batteries in large quantities.

These and other aspects of the various embodiments disclosed herein are achieved in the embodiments discussed below by providing a battery housing apparatus comprised of a first non-conductive sleeve being dimensioned to conform closely to and receive one end of a battery of known dimensions, and a second non-conductive sleeve being dimensioned to conform closely to and receive the other end of the battery of known dimensions. Each sleeve has a substantially constant cross section along its entire length from the closed end to the open end of the sleeve. Accordingly, each sleeve has an interior surface as well as an exterior surface. Upon the insertion of one end of the battery in the open end of the first sleeve, and the insertion of the other end of the battery in the open end of the second sleeve, the Positive and Negative terminals of the battery (i.e., a battery with the Positive terminal at one end and the Negative terminal at the other end, such as in the common AA battery) are protected from outside elements that may discharge or partially discharge the battery. Further, the battery and the battery housing apparatus are in such close relation that the battery is immobilized within the assembly, thereby providing a snug fit and reducing slippage of the sleeve or sleeves. It is not necessary that the two sleeves come in contact with each other or otherwise cover the entire battery. To quickly identify the type of battery and service life left, the sleeves can be color-coded.

According to another embodiment, the battery housing apparatus may accommodate a plurality of batteries instead of a single battery. The multiple-battery housing apparatus would therefore have a first non-conductive sleeve defining two or more cavities being dimensioned to conform closely to and to receive one end of the batteries of known dimensions, and a second non-conductive sleeve defining two or more cavities being dimensioned to conform closely to and to receive the other end of the batteries of known dimensions. Each cavity in each sleeve has a constant cross section along its entire length from the closed end of the cavity to the open end of the cavity. Thus, the sleeve has an exterior surface with multiple interior surfaces that define the number of cavities in the sleeve. Upon the insertion of one end of the batteries in the open end of the cavities of the first sleeve, and the insertion of the other end of the batteries in the open end of the cavities of the second sleeve, the Positive and Negative terminals of the batteries (i.e., a battery with the Positive terminal at one end and the Negative terminal at the other end, such as in the common AA battery) are protected from outside elements that may discharge or partially discharge the batteries. Further, the batteries and the cavities in the multiple-battery housing apparatus are in such close relation that the batteries are immobilized within the assembly, thereby providing a snug fit and reducing slippage of the sleeve or sleeves. It is not necessary that the two sleeves come in contact with each other or otherwise entirely cover the batteries. Further, it is not necessary that all the cavities in the multiple-battery housing apparatus be occupied with a battery. Thus, a multiple-battery housing apparatus that accommodates, e.g., a maximum of four batteries, will still work for its intended purpose if only two batteries are currently housed in the apparatus, leaving two empty slots.

According to another embodiment, the non-conductive sleeve has at least one small air hole per cavity at the closed end so that insertion of the battery through the open end to the closed end is less difficult.

According to yet another embodiment, the non-conductive sleeve(s) is colored for enabling color coordination with existing batteries and/or service life.

In some applications, it is to be understood that two sleeves are not required. For instance, some batteries have both Positive and Negative terminals at one end. Therefore, as long as the sleeve protects those terminals, one goal of the invention is satisfied.

### BRIEF DESCRIPTION OF THE DRAWINGS

FIG. 1 shows a three-dimensional view of a cylindrical battery housing apparatus for a maximum of four said batteries.

FIG. 2 is a cross-sectional side view of the cylindrical battery housing apparatus of FIG. 1.

FIG. 3 is a bottom view of the cylindrical battery housing apparatus of FIG. 1.

FIG. 4 is a side view of the cylindrical battery housing apparatus of FIG. 1.

FIG. 5 is a cross-sectional side view of one half of the cylindrical battery housing apparatus of FIG. 1.

FIG. 6 is a top view (looking into the cavities) of the cylindrical battery housing apparatus of FIG. 1.

FIG. 7 is a cross-sectional side view of one half of the cylindrical battery housing apparatus of FIG. 1.

FIG. 8 is a top view of the cylindrical battery housing apparatus of FIG. 1 in which the Positive terminals are facing upward.

FIG. 9 is a cross-sectional side view of the cylindrical battery housing apparatus of FIG. 1.

FIG. 10 is a cross-sectional view of one sleeve.

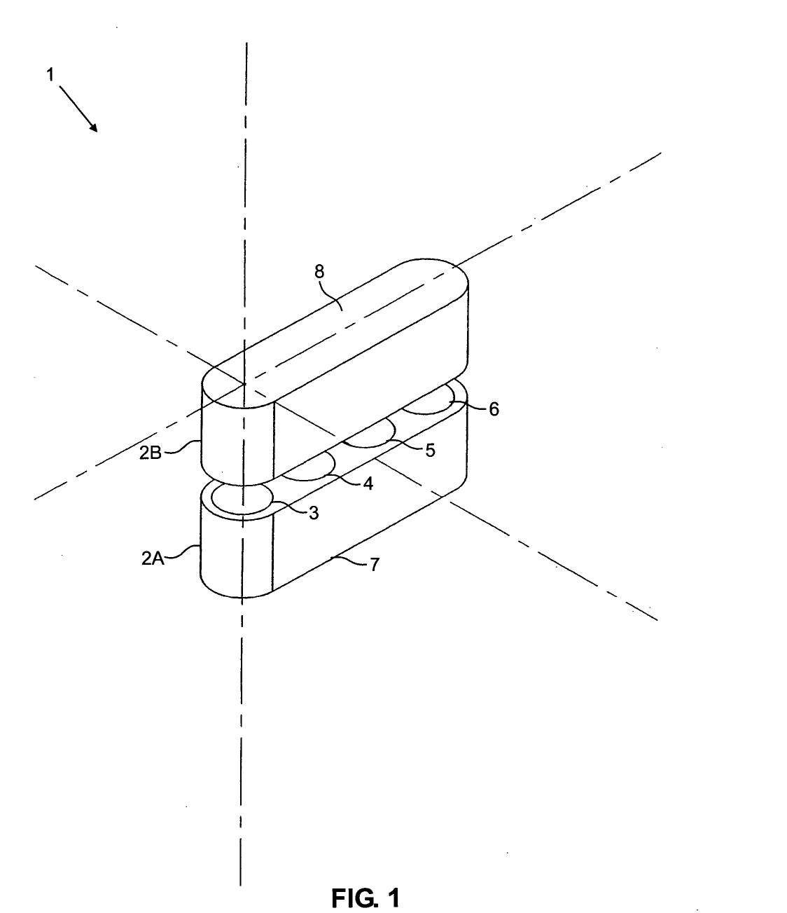

Referring now in detail to the figures, FIG. 1 shows a battery housing apparatus that can store up to four cylindrical batteries. The housing apparatus 1 comprises two sleeves, 2A and 2B. The first sleeve 2A defines four annular openings 3, 4, 5, and 6 for cylindrical-battery insertion. The four annular openings 3, 4, 5, and 6 preferably have a substantially constant cross section along the height of the first sleeve 2A (thereby cylindrically dimensioned to receive a cylindrical battery) from the insertion point (annular openings 3, 4, 5, and 6) until reaching the other closed end 7. Thus, the annular openings 3, 4, 5, and 6 represent a cavity where cylindrical batteries may be inserted. While not apparent in FIG. 1, the second sleeve 2B has a shape substantially similar to the first sleeve 2A, so that the second sleeve 2B also defines four annular openings with constant cross sections along the height of the second sleeve 2B until reaching the closed end 8. As a result, the second sleeve 2B can fit over cylindrical batteries that are inserted into the first sleeve 2A. The reverse is also true: the first sleeve can fit over cylindrical batteries that are inserted into the second sleeve 2A.

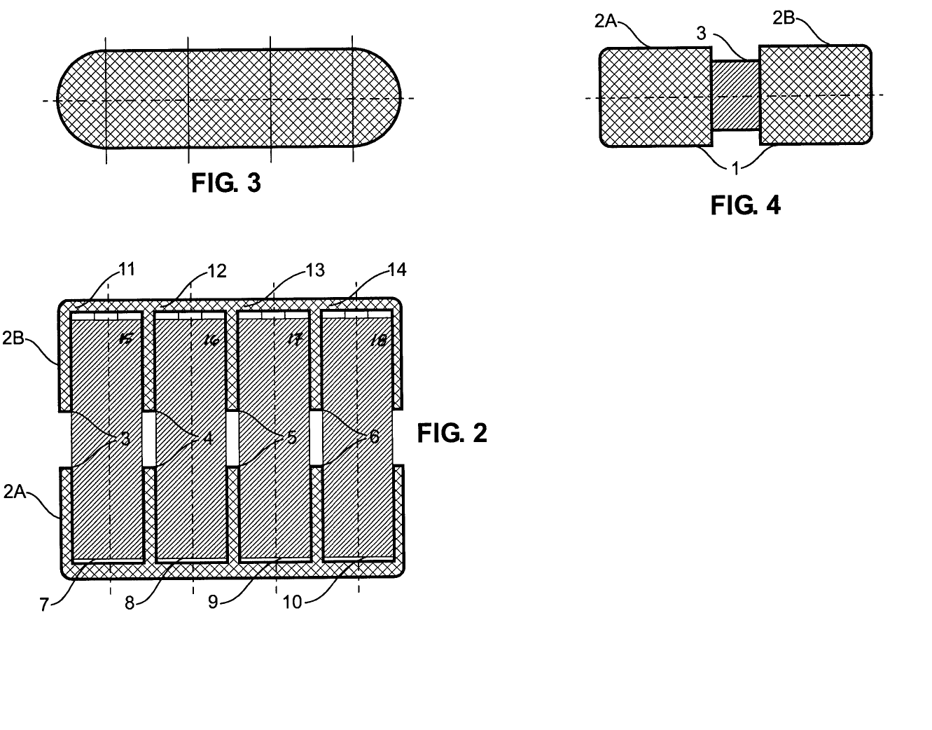

FIG. 2 is a cross-sectional side view of the cylindrical battery housing apparatus of FIG. 1. As shown, the housing apparatus 1 comprises two sleeves, 2A and 2B. The four annular openings 3, 4, 5, and 6 defined by the sleeves have a substantially constant cross section along the height of the housing apparatus 1 (thereby cylindrically dimensioned to receive cylindrical batteries 15, 16, 17, and 18) from the insertion point (annular openings 3, 4, 5, and 6) to the other closed ends 7, 8, 9, and 10 of first sleeve 2A and the closed ends 11, 12, 13, and 14 of second sleeve 2B. Thus, the second sleeve 2B can fit over cylindrical batteries 15, 16, 17, and 18 that are inserted into the first sleeve 2A, or vise versa. In FIG. 2, the second sleeve 2B fits over the Positive terminal of the cylindrical battery. However, it is to be understood that it is not necessary that the Positive or Negative terminals all face the same direction.

FIG. 3 is a bottom view of the cylindrical battery housing apparatus of FIG. 1. As shown, the outer corners are preferably rounded which serves to accommodate the cylindrical batteries contained in the housing apparatus and to save space. Other shapes can be used for the outer corners without departing from the teachings herein.

FIG. 4 is a side view of the cylindrical battery housing apparatus of FIG. 1. As shown, the housing apparatus 1 comprises two sleeves 2A and 2B. The first sleeve 2A fits over one end of the battery 3, while the second sleeve 2B fits over the other end of the battery 3. The first sleeve 2A and the second sleeve 2B are generally the same size, and partially expose the battery 3 in the middle. It is to be understood that the housing apparatus 1 can also completely cover the battery without departing from the teachings herein. However, by partially exposing the battery the user may more readily identify the battery size, chemistry, and manufacturer.

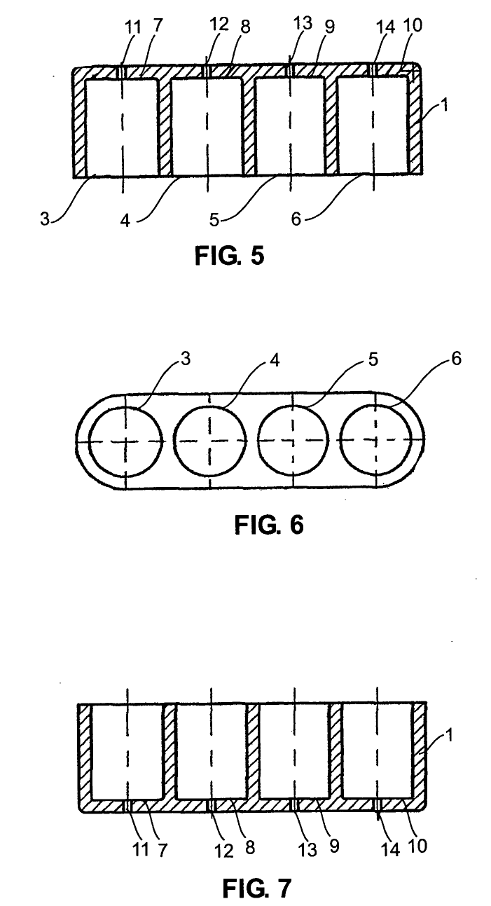

Referring now to FIG. 5, shown is a cross-sectional side view of one half of the cylindrical battery housing apparatus of FIG. 1. As discussed regarding FIG. 1, the four annular openings 3, 4, 5, and 6 defined by sleeves 2A and 2B have a substantially constant cross section along the height of the housing apparatus 1 (thereby cylindrically dimensioned to receive a cylindrical battery) from the insertion point (annular openings 3, 4, 5, and 6) to the other closed ends 7, 8, 9, and 10. However, the closed ends 7, 8, 9, and 10 are not completely sealed, instead closed ends 7, 8, 9, and 10 each define an air hole 11, 12, 13, and 14. The air hole 11, 12, 13, and 14 at the closed ends 7, 8, 9, and 10 of the housing apparatus 1 serve as air compression relief to allow easier insertion of a cylindrical battery. The air holes 11, 12, 13, and 14 preferably have a diameter that is smaller than the terminals on the batteries being stored. Having the air holes 11, 12, 13, and 14 smaller in diameter than the battery terminals significantly reduces the possibility that the terminals could come into contact with external objects that could result in battery discharge.

FIG. 6 is a top view (looking into the cavities) of one sleeve of the housing apparatus of FIG. 1. Thus, the annular openings 3, 4, 5 and 6 defined by sleeves 2A and 2B are depicted head on, revealing the circular cavities. The outer corners are preferably rounded which serves to accommodate the cylindrical batteries contained in the housing apparatus and to save space. Other shapes can be used for the outer corners without departing from the teachings herein.

In FIG. 7 is shown a cross-sectional side view of one half of the cylindrical battery housing apparatus of FIG. 1, and is substantially similar to the sleeve shown in FIG. 5. As discussed regarding FIG. 1, the four annular openings 3, 4, 5, and 6 defined by sleeves 2A and 2B have a substantially constant cross section along the height of the housing apparatus 1 (thereby cylindrically dimensioned to receive a cylindrical battery) from the insertion point (annular openings 3, 4, 5, and 6) to the other closed ends 7, 8, 9, and 10. However, the closed ends 7, 8, 9, and 10 are not completely sealed. Instead closed ends 7, 8, 9, and 10 each define an air hole 11, 12, 13, and 14. The air hole 11, 12, 13, and 14 at the closed ends 7, 8, 9, and 10 of the housing apparatus 1 serve as air compression relief to allow easier insertion of a cylindrical battery. The air holes 11, 12, 13, and 14 preferably have a diameter that is smaller than the terminals on the batteries being stored. Having the air holes 11, 12, 13, and 14 smaller in diameter than the battery terminals significantly reduces the possibility that the terminals could come into contact with external objects that could result in battery discharge. Thus, the embodiment in FIG. 5 can be used as the first sleeve 2A (of FIG. 1) while the embodiment of FIG. 7 can be used as the second sleeve 2B (of FIG. 1), or vice versa.

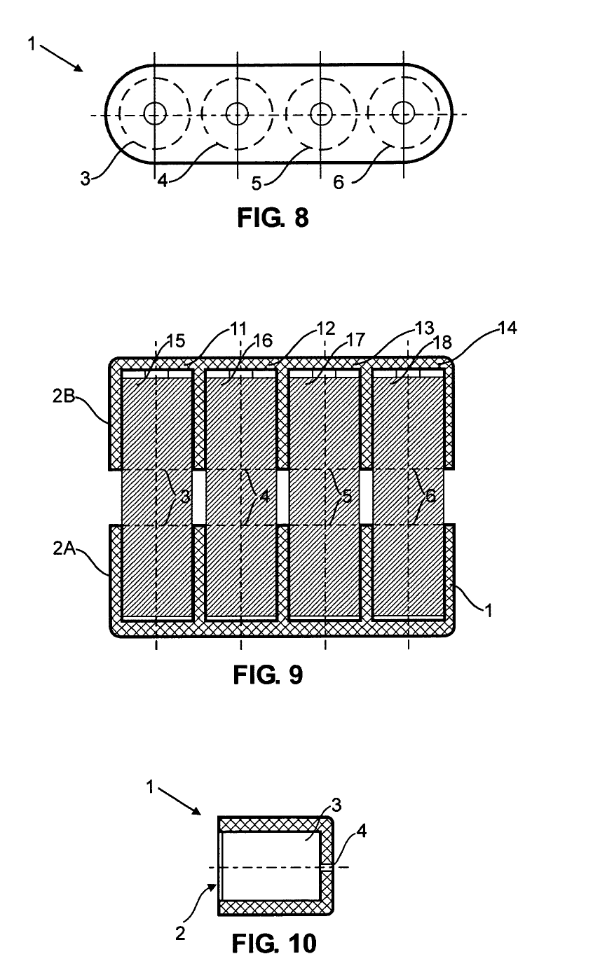

FIG. 8 is a top view of one sleeve 1 of FIG. 1 (first sleeve 2A or second sleeve 2B) in which the Positive terminals of the batteries (not shown) have been inserted into the sleeve 1. Shadowed in FIG. 8 are the four annular openings 3, 4, 5, and 6 defined by sleeves 2A and 2B to which the batteries (not shown) are inserted.

FIG. 9 is substantially similar to FIG. 2, showing a cross-sectional side view of the cylindrical battery housing apparatus of FIG. 1. As shown, the housing apparatus 1 comprises two sleeves, 2A and 2B. The four annular openings 3, 4, 5, and 6 defined by sleeves 2A and 2B have a substantially constant cross section along the height of the housing apparatus 1 (thereby cylindrically dimensioned to receive cylindrical batteries 15, 16, 17, and 18) from the insertion point (annular openings 3, 4, 5, and 6) to the other closed ends 7, 8, 9, and 10 of first sleeve 2A and the closed ends 11, 12, 13, and 14 of second sleeve 2B. Thus, the second sleeve 2B can fit over cylindrical batteries 15, 16, 17, and 18 that are inserted into the first sleeve 2A, or vise versa. In FIG. 9, the second sleeve 2B fits over the Positive terminal of the cylindrical battery. However, it is to be understood that it is not necessary that the Positive or Negative terminals all face the same direction.

FIG. 10 is a cross-sectional view of one sleeve 1 defining an opening 2 with a substantially constant cross-section through the length of the sleeve to the other closed end 3. The closed end 3 of this embodiment is not completely sealed. Closed end 3 of this embodiment defines an air hole 4. The air hole 4 at the closed end 3 of the one sleeve 1 serve to allow easier insertion of a battery. The air hole 4 preferably has a diameter that is smaller than the terminals on the battery being stored. Having the air hole 4 smaller in diameter than the battery terminal significantly reduces the possibility that the terminal(s) could come into contact with external objects that could result in battery discharge.

The sleeves of the present invention can be constructed of a soft, flexible and non-conductive material such as Polyvinyl Chloride. The sleeves may also be manufactured in a variety of standard dimensions as needed or by preference, depending upon the size of batteries to be stored.

The dimensions of a housing apparatus of FIG. 1, which depicts a housing apparatus made to fit four cylindrical AA batteries, will now be described. Common AA batteries are assumed to have a diameter of approximately 0.550 inch. The sleeves may be manufactured with a height of 0.88 inch for the first sleeve and 0.78 inch for the second sleeve, a length of 2.748 inch, and a width of 0.762 inch. The cavities defined by sleeves that store AA batteries have a diameter of 0.550 inch and whose centers are spaced 0.662 inch apart, leaving approximately 0.100 inch of wall thickness between the cavities and generally elsewhere. The air holes have a diameter of 0.06 inch. A preferred way to manufacture the sleeves is to use a plastic injection molding process or dip process. It is to be understood that these dimensions discussed herein are just one of countless possible embodiments. For instance, the height of the first sleeve can be identical to the height of the second sleeve without departing from the teachings herein. Likewise, the height of the first sleeve can be substantially different from the height of the second sleeve. Furthermore, the thickness of the sleeves may vary without departing from the teachings herein. It is also to be understood that dimensions may vary for different sizes and shapes of batteries. Indeed, the dimensions for a battery housing apparatus fit for storing in a drawer may be drastically different from a battery housing apparatus for shipping mass quantities. Thus, the dimensions disclosed herein are in no way intended to limit the scope of the various embodiments.

In the various embodiments disclosed herein, the material used to construct the housing apparatus 1 preferably has a certain degree of tackiness, which acts to snuggly hold the batteries within the respective sleeves 2A and 2B. Various details of the invention may be changed without departing from its scope. For instance, instead of an air hole, the material used could also be constructed of a mesh-like material, rendering the use of air holes redundant and unnecessary.

The foregoing description of the drawings are provided for the purpose of illustration only and not for the purpose of limitation—the invention being defined by the claims.

1. A battery storage apparatus comprising:
a housing, said housing comprising a non-conductive sleeve having an open end, a closed end, and a substantially constant cross section along its entire length from the open end to the closed end, and said sleeve being dimensioned to conform closely to and receive a battery of known dimensions, the length of said sleeve being shorter than the length of said battery.

2. The battery storage apparatus of claim 1, wherein
said housing defines more than one cavity, each cavity having an open end, a closed end, and a substantially constant cross section along its entire length from the open end to the closed end, said cavities being dimensioned to conform closely to and receive one or more batteries of known dimensions, the length of said sleeve being shorter than the length of said battery or batteries.

3. The battery storage apparatus of claim 1, wherein the closed end of the sleeve defines at least one aperture large enough for air to pass through.

4. The battery storage apparatus of claim 2, wherein the closed ends of the housing defines at least one aperture large enough for air to pass through.

5. The battery storage apparatus of claim 3, wherein said aperture has a diameter smaller than a diameter of a battery terminal.

6. The battery storage apparatus of claim 4, wherein said aperture has a diameter smaller than a diameter of a battery terminal.

7. A battery storage apparatus comprising a housing, said housing comprising:
(a) a first non-conductive sleeve having an open end, a closed end, and a substantially constant cross section along its entire length from the open end to the closed end, said first sleeve being dimensioned to conform closely to and receive a battery of known dimensions, the length of said first sleeve being shorter than the length of said battery; and
(b) a second non-conductive sleeve having an open end, a closed end, and a substantially constant cross section along its entire length from the open end to the closed end, said second sleeve being dimensioned to conform closely to and receive the exposed end of said battery of known dimensions, the length of said second sleeve approximately the length of said exposed battery.

8. The battery storage apparatus of claim 7, wherein
(a) the first non-conductive sleeve defines more than one cavity, each cavity having an open end, a closed end, and a constant cross section along its entire length from the open end to the closed end, each of said cavities being dimensioned to conform closely to and receive one or more batteries of known dimensions, the length of said first sleeve shorter than the length of said battery or batteries; and
(b) the second non-conductive sleeve defines more than one cavity, each cavity with an open end, a closed end, and a constant cross section along its entire length from the open end to the closed end, each of said cavities being dimensioned to conform closely to and receive the exposed end of said battery or batteries of known dimensions, the length of said second sleeve approximately the length of said exposed battery or batteries.

9. The battery storage apparatus of claim 7, wherein the closed end of the first sleeve defines at least one aperture large enough for air to pass through and the closed end of the second sleeve defines at least one aperture large enough for air to pass through.

10. The battery storage apparatus of claim 8, wherein the closed ends of the first sleeve define at least one aperture large enough for air to pass through and the closed ends of the second sleeve define at least one aperture large enough for air to pass through.

11. The battery storage apparatus of claim 9, wherein said aperture has a diameter smaller than a diameter of a battery terminal.

12. The battery storage apparatus of claim 10, wherein said aperture has a diameter smaller than a diameter of a battery terminal.
